(19) United States
(12) Patent Application Publication
(10) Pub. No.: US 2011/0285660 A1
(43) Pub. Date: Nov. 24, 2011

(54) TOUCH SCREEN POWER GENERATION

(76) Inventors: KRISHNANAND PRABHU, Bangalore (IN); Jagadish Vasudeva Singh, Bangalore (IN)

(21) Appl. No.: 12/782,494

(22) Filed: May 18, 2010

(51) Int. Cl. G06F 3/041

(52) U.S. Cl. 345/174

(57) ABSTRACT

A method and apparatus converts a force applied to a touch screen of an electronic device into an electric charge capable of powering a logical circuit of the electronic device. In various embodiments, the touch screen comprises one or more piezoelectric transducer array layers that convert the force into electrical charges. The converted electrical charges may be collected in a capacitor array layer, which can be discharged in order to power logical circuits of the electronic device or to charge a battery of the electronic device.

### FIELD

The disclosed embodiments relate generally to touch screens and more particularly to power generation in electronic devices having a touch screen.

### BACKGROUND

As electronic devices become increasingly prevalent in our daily lives, it is important to improve the ease with which users may interact with these devices. The “touch screen” is one way in which users can interact with various electronic devices, such as wireless mobile communication devices. For example, by simply touching the touch screen of a wireless mobile communication device with a finger or a stylus, a user can easily perform a number of tasks (e.g., navigating menus, making selections, configuring applications, etc.).

### SUMMARY

A power-generating touch screen converts a force applied to a touch screen of an electronic device into an electric charge capable of powering a logical circuit of the electronic device. In various embodiments, the touch screen comprises one or more piezoelectric transducer array layers that convert the force into electrical charges. The converted electrical charges are collected in a capacitor array layer, which is discharged in order to power logical circuits of the electronic device or to charge a battery of the electronic device.

### BRIEF DESCRIPTION OF THE DRAWINGS

FIG. 1 is an exploded view of one embodiment of a touch screen.

FIG. 2 shows an embodiment of a PETA layer coupled to the capacitor array layer.

FIG. 3 is an example of an electronic device with a touch screen.

FIG. 4 is a block diagram of one embodiment of the components contained in the electronic device of FIG. 3.

FIG. 5 is a flow chart showing an embodiment of a method of charging and discharging a capacitor array layer.

FIG. 6 is a flow chart showing an embodiment of a method of selecting a logical circuit to be powered.

FIG. 7 shows one embodiment of a list of logical circuits, each having a priority level that may be used to select which logical circuit is to be powered.

### DETAILED DESCRIPTION

The word “exemplary” is used herein to mean “serving as an example, instance, or illustration.” Any embodiment described herein as “exemplary” is not necessarily to be construed as preferred or advantageous over other embodiments. In addition, references to “an,” “one,” “other,” “another,” “the,” “this,” “alternative,” “some,” or “various” embodiments should not be construed as limiting since various aspects of the disclosed embodiments may be used interchangeably within other embodiments.

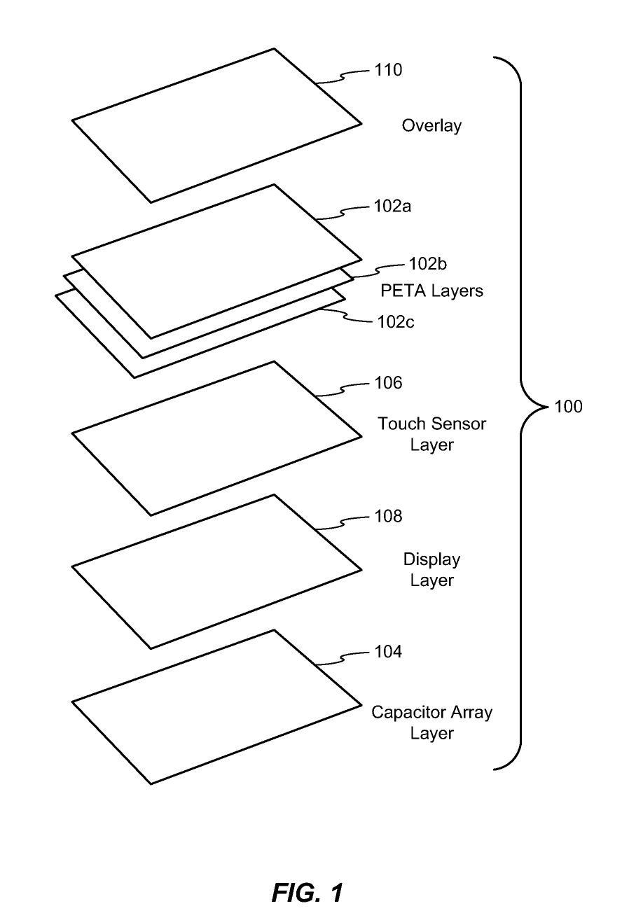

Turning now to FIG. 1, an exploded view of one embodiment of a power-generating touch screen is shown. A touch screen may be advantageously used as an input mechanism such that a user can touch the screen to provide inputs to a device. As used herein, a “touch” refers to a force imparted by a user upon a touch screen. This force may be imparted with any object chosen by the user, including, for example, a part of the user's body (e.g., a finger or fingernail), a stylus, a pen, or any other object selected by the user. Touch screen 100 of FIG. 1 is capable of generating power from the touches (e.g., force imparted by the touches) made by the user onto touch screen 100.

For the example of FIG. 1, the touch screen 100 includes a plurality of piezoelectric transducer array (“PETA”) layers 102a, 102b, and 102c. In various embodiments, any number of PETA layers may be used, including only a single PETA layer. Regardless of the number of PETA layers included in the touch screen 100, each PETA layer includes a plurality of piezoelectric transducer (“PET”) elements. A PET element is a transducer that utilizes piezoelectric material. A transducer is a device that can convert one type of energy into another type of energy. Piezoelectric material is a material that produces an electric charge when a force is applied to the material. Thus, a PET can convert mechanical stress (e.g., force from a touch) into electrical energy (e.g., electrical charge).

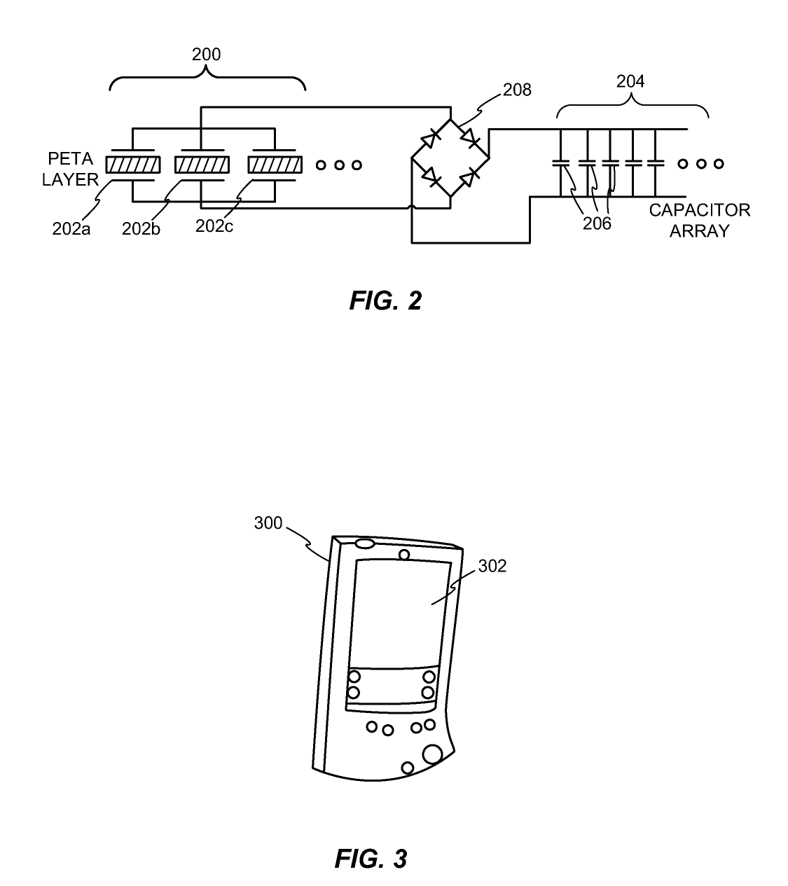

The PET elements may be arranged in any configuration, including an array that forms each PETA layer. Referring briefly to FIG. 2, the PETA layer 200 is shown to include a small array of PET elements 202a, 202b, and 202c. For the examples discussed herein, each PETA layer is comprised of an array of PET elements mounted in a transparent plastic substrate. An example of suitable size for each PET is micrometer-sized or nanometer-sized. This relatively small size allows, for example, millions of PETs to be densely packed into each PETA layer. Other size PETs, larger or smaller, may be used, which could increase or decrease the number of PETs included in each PETA layer.

Although other arrangements may be used in some circumstances, the PETs are packed and arranged such that the pressure produced (e.g., force applied) when a user touches the screen is used to fire as many PETs as possible within the area upon which the force from the touch is being imparted. Moreover, the small size of the PETs ensures that the PETA layers are practically transparent, allowing a user to clearly see any other layers of the touch screen 100 that may be positioned beneath the PETA layers 102.

When force from a user touch is imparted onto the PETs of the PETA layers 102, each PET that experiences the force generates a small electric charge (e.g., converts the force into an electrical charge). In accordance with the exemplary embodiment, the electric charges are to charge the capacitor array layer 104, which is coupled to the PETA layers 102. The capacitor array layer 104 includes a plurality of capacitors in the example shown. Although a single capacitor array layer 104 is discussed herein, multiple capacitor array layers may be used in some circumstances. As discussed with reference to FIG. 2, an example of a suitable connection configuration includes connecting the capacitors of the capacitor array layer 104 in parallel.

FIG. 2 is a schematic illustration of an array layer 204 including capacitors 206 connected in parallel and connected to the PETA layer 200. In the example shown in FIG. 2, the capacitor array layer 204 is coupled to the PETA layer 200 by a rectifier circuit 208. Although other types of rectifiers may be used in some circumstances, the rectifier circuit 208 is a diode rectifier circuit in this example. Electrical charges generated by the PETA layer 200 may be rectified by the rectifier circuit 208 prior to being used to charge the capacitors 206 of the capacitor array layer 204. In the embodiment shown, the diode rectifier circuit 208 is used to ensure that the polarity of the charges sent to the capacitor array layer 204 is the same regardless of the polarity of the charges input to the diode rectifier circuit 208 from the PETA layer 200. Either positive or negative charges (e.g., different polarities) may be generated by the PETA layer 200, depending on the direction of the force applied to the PETA layer 200 by the user, and the diode rectifier circuit 208 compensates for the different polarities that may be generated.

The connection of the capacitors 206 in parallel allows the charges to be evenly distributed over the capacitors 206 of the capacitor array layer 204. In some circumstances, the capacitors 206 have a high voltage rating. Examples of suitable types of capacitors include high capacity electrolytic capacitors. The capacitor array layer 204 may be replaced by any device or structure capable of receiving a charge from the PETA layer 200 and storing the charge. One example of such a device includes a battery. Similarly, the PETA layer 200 could be replaced by any device or structure capable of transforming force from a user touch into electrical charge.

Where a PETA layer is used, the charge developed by the PETA layer can be given by:

Q=d×P×A_{eff} (Equation 1)

### Where:

‘Q’ is the charge accumulated in Coulombs.
‘P’ is the pressure applied in Pascals.
‘d’ is the piezoelectric constant relating the mechanical strain produced by an applied electric field (meter/volt).
‘A_{eff}’ is the effective area that experiences pressure in m².
Also, where multiple stacks of the PETA layer are used, the charge is multiplied by the number of PETA layers used.

Taking the piezoelectric transducers' capacitance into consideration, the voltage developed is,

V=(d×P×A_{eff})/(C_{P}) (Equation 2)

### Where:

### Cp is the Effective Parallel Capacitance.

The Energy generated can be given by,

E=(C_{P}×((d×P×A_{eff})/(C_{P}))²)/2 (Equation 3)

### Where:

‘d’ for a widely used Piezoelectric material—Poly Vinylidene Flouride (“PVDF”)—is 23×10⁻¹² m/V, considering one dimensional stress. Pressure due to the finger can be assumed at around 1 kPa. The ‘A_{eff}’ can be approximated to be 1 cm², considering a single finger. The Cp in the case of PVDF is 1.36 nF.

Thus, the voltage generated by a single PETA layer is ˜2.3 mV for a particular example. Where a large number of PETA layers are used, the voltage generated will be much higher and result in a more easily usable amount of energy. An example of a large number is ten thousand PETA layers.

For the example referred to with reference to FIG. 1, the touch screen 100 includes additional layers beyond the PETA layers 102 and the capacitor array layer 104. The touch screen 100 includes a touch sensor layer 106 positioned below the PETA layers 102. The touch sensor layer 106, however, may be positioned above or below the PETA layers 102 and may not necessarily be directly positioned adjacent to the PETA layers 102, as shown. Regardless of the position of the touch sensor layer 106 relative to the PETA layers 102, the touch sensor layer 106 senses the force of a user touch within a specified area of the touch screen and translates the application of force in the specified area into an input command (e.g., a selection, a command, or other input instruction). The input command is sent to a processor or controller (not shown) associated with the touch screen 100 in order to be processed.

The touch screen 100 also includes a display layer 108. For the example, the display layer 108 is positioned between the touch sensor layer 106 and the capacitor array layer 104. The display layer 108, however, may be placed in other positions relative to the other layers of the touch screen 100. Regardless of the position of the display layer 108 within the touch screen 100, the display layer 108 may display information (e.g., text, pictures, graphics, icons, video, etc.) for a user. For the example, the display layer 108 comprises a liquid crystal display (“LCD”), which is a thin, flat panel used for electronically displaying information. An LCD is an electronically-modulated optical device made up of any number of pixels filled with liquid crystals and arrayed in front of a light source (e.g., backlight) or reflector to produce images in color or monochrome. Although an LCD is described, any other suitable display technology may be used in the display layer 108.

The touch screen 100 also includes the overlay 110 in the exemplary embodiment. An example of suitable structure of the overlay 110 includes using a layer of material that is substantially transparent, flexible, and thin so that the other layers of the touch screen 100 may be visible to the user and so that the force imparted onto the touch screen 100 can be adequately imparted onto the PETA layers 102 and the touch sensor layer 106. As described above, the layers of the touch screen 100 may be rearranged, omitted, or substituted with other materials, devices, or structures that accomplish the same functionality. In some circumstances, additional layers not shown in FIG. 1 may be included. Also, more than one of a particular type of layer may be included. For example, more than one display layer may be used to create a different visual display effect for the user.

FIG. 3 shows an example of an electronic device 300, which includes a touch screen 302. An example of a suitable touch screen 302 includes the touch screen 100 of FIG. 1. For the example of FIG. 3, the electronic device 300 is shown as a wireless mobile communication device. More specifically, the electronic device 300 may be a smartphone (e.g., a mobile phone offering advanced capabilities, often with personal computer-like functionality). Alternatively, the electronic device 300 may be a wireless mobile telephone. The electronic device 300 is not limited to just communication devices. Accordingly, the electronic device 300 could be any electronic device with a touch screen (e.g., personal digital assistant, digital camera, camcorder, etc.). Moreover, the electronic device 300 could be battery-powered and/or powered by an electrical cord plugged into an electrical socket of a building.

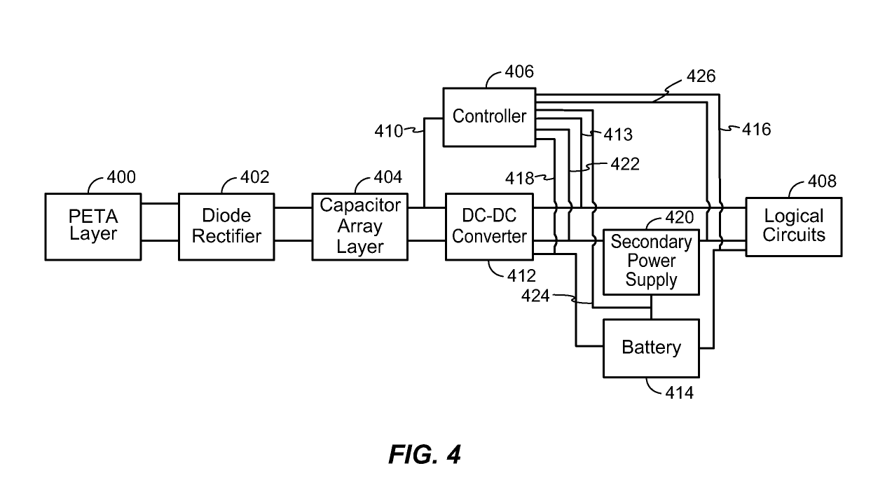

FIG. 4 is a block diagram of an exemplary embodiment of at least some of the components contained in the electronic device 300 of FIG. 3. The components may include a power-generating touch screen comprising a PETA layer 400. An example of a suitable PETA layer 400 includes a PETA layer including a plurality of PET elements. The PETA layer 400 is coupled to a rectifier circuit 402 in order to standardize the polarity of electric charges that are sent to the capacitor array layer 404. Although other types of rectifiers may be used in some circumstances, the rectifier circuit 402 is diode rectifier circuit in this example.

The capacitor array layer 404 is coupled to the PETA layer 400 by the diode rectifier circuit 402. However, in various embodiments, the diode rectifier circuit 402 may be omitted or replaced with other circuitry that has the same functionality as the diode rectifier circuit 402. The capacitor array layer 404 includes a plurality of capacitors that may be charged by the PETs of the PETA layer 400 in response to a force being applied to the PETA layer 400. As discussed above, a plurality of capacitor array layers may be used in some circumstances.

The capacitor array layer 404 is coupled to the controller 406. The controller 406 is configured to determine a charge level of the capacitor array layer 404 and to control the discharge of the capacitor array layer 404 based on the determined charge level. The controller 406 is any computer, processor, processor arrangement logic circuit, or combination thereof that performs the control functions discussed herein. In some circumstances, the controller 406 is the only controller within the electronic device 300, effectively handling all processing and control functions for electronic device 300, including controlling the discharge of the capacitor array layer 404. Accordingly, the controller may facilitate the overall functionality of the electronic device 300. In other situations, the controller 406 is only configured to control the discharge of the capacitor array layer 404 while another one or more controllers (not shown) are configured to handle all other processing functions of the electronic device 300 that are not related to the discharge of the capacitor array layer 404. In yet other embodiments, controller 406 is configured to control the discharge of the capacitor array layer 404 as well as some, but not all, of the other processing requirements of the electronic device 300.

The discharge of the capacitor array layer 404 may take many forms. In this regard, various examples of circuitry may be used alone or in combination to discharge the capacitor array layer 404 and to also charge other components with the discharged electric charge from the capacitor array layer 404. Several examples of such discharging circuitry and charging circuitry are described below. Other circuit and component configurations beyond those shown below may be used to discharge the capacitor array layer 404 and to charge other components with the discharged electric charge from the capacitor array layer 404.

For example, the controller 406 may determine that the capacitor array layer 404 should be discharged directly to power one or more logical circuits 408 of the electronic device. In order to accomplish this, the controller 406 sends a signal via the line 410 to discharge the capacitor array layer 404 to DC-DC (e.g., Direct Current to Direct Current) converter 412 coupled to the capacitor array layer 404. The DC-DC converter 412 ensures that the electric charge sent to the logical circuits 408 is of the proper voltage and/or current. The controller 406 also sends a signal via the line 413 to switch the output of the DC-DC converter 412 to the logical circuits 408. In addition, the controller 406 would cut, or at least reduce the level of, the power supply from the battery 414 of the electronic device to the logical circuits 408. An example of a suitable technique for disconnecting the battery 414 includes sending a control signal from the controller 406 during the time that the logical circuits 408 are being powered by the charge from the capacitor array layer 404. Once the charge from the capacitor array layer 404 can no longer adequately power the logical circuits 408, the power supply from the battery 414 may be restored. In some circumstances, the power supply from the battery 414 may be restored prior to the point in time at which the charge from the capacitor array layer 404 can no longer power the logical circuits 408.

In some situations, the DC-DC converter 412 is omitted. For example, if the voltage of the electric charge that is discharged from the capacitor array layer 404 is appropriate for whichever of the logical circuits 408 are to be powered by the electric charge, the DC-DC converter 412 may be omitted. In some circumstances, the DC-DC converter 412 may still be present but may just be bypassed if the voltage of the electric charge that is discharged from the capacitor array layer 404 is appropriate for whichever of the logical circuits 408 are to be powered by the electric charge.

Also, the logical circuits 408, although shown as a single entity, may alternatively represent separate logical circuits. For example, logical circuits that may be powered by the electric charge from the capacitor array layer 404 may include a real-time clock, a liquid crystal display, or a backlighting device.

In another embodiment, the controller 406 may determine that the battery 414 should be recharged with the electric charge stored in the capacitor array layer 404. In this case, the controller 406 sends a signal via the line 410 to discharge the capacitor array layer 404 to the DC-DC converter 412, ensuring that the electric charge has the proper voltage to charge the battery 414. The controller 406 also sends a signal via the line 418 to switch the output of the DC-DC converter 412 to the battery 414. Alternatively, the DC-DC converter may be omitted or bypassed if the voltage of the electric charge from the capacitor array layer 404 is appropriate for the battery 414.

In some circumstances, the controller 406 determines that the charge from the capacitor array layer 404 should be discharged to a secondary power supply 420. The secondary power supply 420 is any device or structure capable of storing a charge and releasing the stored charge in order to recharge the battery 414 or to power the logical circuits 408. For example, the secondary power supply 420 could be a super capacitor, which is an electrochemical capacitor that has an unusually high energy density when compared to common capacitors, typically on the order of thousands of times greater than a high capacity electrolytic capacitor. Where a super capacitor is used, the super capacitor may have a low voltage rating and a high capacitance. In other circumstances, the secondary power supply 420 is another battery.

Regardless of the exact device used as the secondary power supply 420, the controller 406 discharges the capacitor array layer 404 by sending a signal via the line 410 to discharge the capacitor array layer 404 to the DC-DC converter 412. In this example, the controller 406 also sends a signal via the line 422 to switch the output of the DC-DC converter 412 to the secondary power supply 420. Alternatively, the DC-DC converter 412 may be omitted or bypassed if the voltage of the electric charge from the capacitor array layer 404 is proper for the secondary power supply 420.

After the secondary power supply 420 is charged, the controller 406 may discharge the secondary power supply 420 in order to charge the battery 414 by sending a signal via the line 424 to discharge the secondary power supply 420. Alternatively, the controller 406 may discharge the secondary power supply 420 in order to power the logical circuits 408 by sending a signal via the line 426 to discharge the secondary power supply 420. The controller 406 may also cut, or at least reduce the level of, the power supply to the logical circuits 408 from the battery 414 as long as power is being supplied to the logical circuits 408 by the secondary power supply 420. Controller 406 can cut or reduce the power supply from the battery 414 by sending a signal via the line 416.

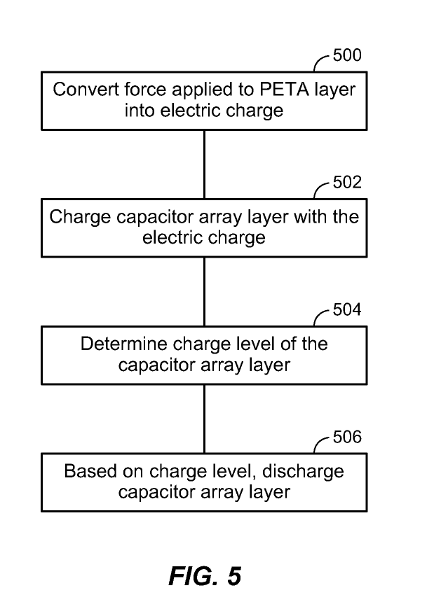

One embodiment of a method is shown is shown in FIG. 5. At block 500, force applied to a PETA layer of a touch screen (e.g., touch screen 100 of FIG. 1) is converted into an electric charge. As described above, the PETs of the PETA layer enable this conversion. However, any other device or structure may be used that can make such a conversion. At block 502, a capacitor array layer of the touch screen is charged with the electric charge that was created at block 500. For example, the plurality of capacitors of the capacitor array layer are charged with the electric charge.

At block 504, the charge level of the capacitor array layer is determined. As described above, a controller is used to determine the charge level. Alternatively, any other suitable circuitry and/or components may be used that are capable of determining the charge level. In this regard, “determined” can mean many things. For example, “determined” can mean identified, calculated, derived, measured, etc.

At block 506, the capacitor array layer is discharged, based on the determined charge level. As described previously, the charged capacitor array layer may be discharged in order to power one or more logical circuits of an electronic device. In some situations, the method may further include selecting one or more of a plurality of logical circuits to be powered by discharging the capacitor array layer. This selection may be based on the determined charge level, on a priority level associated with each logical circuit, on whether the determined charge level is sufficient to power a logical circuit for at least a predetermined minimum period of time, or on a combination of these criteria.

In some circumstances, the capacitor array layer is discharged in order to charge a battery of an electronic device, to charge a secondary power source of the electronic device, or both. If the battery of the electronic device is charged with the electric charge from the capacitor array layer, the battery may be used to power the logical circuits. If the secondary power source is charged with the electric charge from the capacitor array layer, the secondary power source may be discharged in order to power the logical circuits. Alternatively, the charged secondary power source may also be discharged in order to charge the battery.

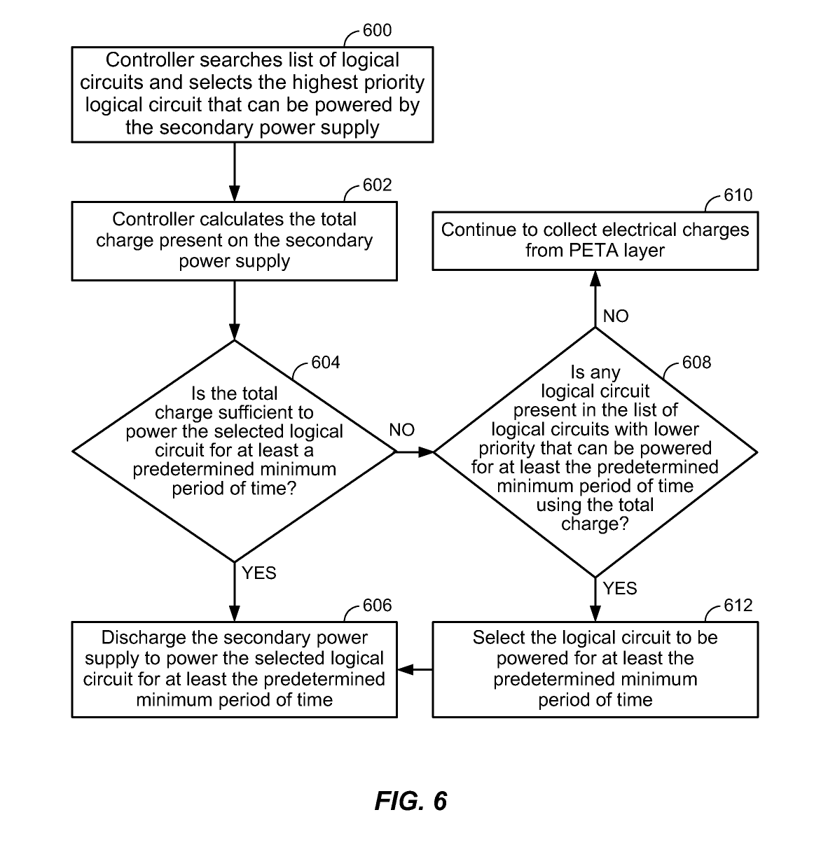

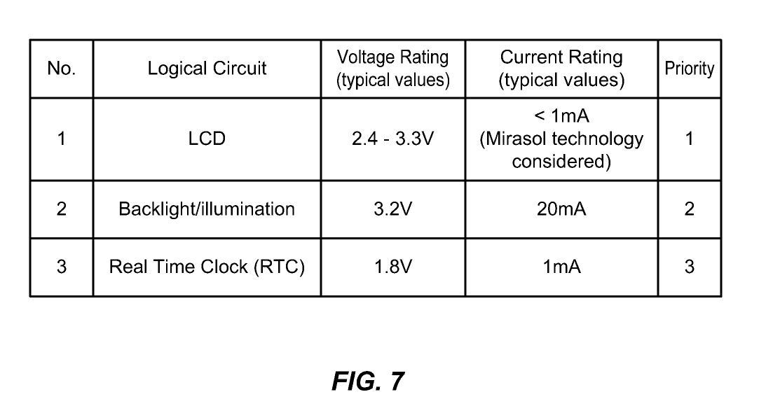

Referring now to FIG. 6, one embodiment of a method of selecting which logical circuit to power by discharging the charged secondary power supply is shown. At block 600, a controller searches a list of logical circuits and selects the logical circuit with the highest priority that can be powered by the secondary power supply. An example of a list of logical circuits, each having an assigned priority, can be seen in FIG. 7. It is worth noting that in some embodiments, not all of the logical circuits of the electronic device may be present in the list. In fact, some logical circuits may be included on the list at times or omitted from the list at other times. Moreover, the priority level assigned to each logical circuit can be fixed or can be dynamically modified based on any criteria (e.g., power profile selected by user, existing battery charge level, existing secondary power source charge level, time of day, geographic location, likelihood of user touching the touch screen, etc.).

At block 602, the controller calculates the total charge present on the secondary power supply. At decision block 604, the controller determines if the total charge is sufficient to power the selected logical circuit for at least a predetermined minimum period of time. In various embodiments, the predetermined minimum period of time may be different for each logical circuit. In addition, the minimum period of time may be fixed or may be modified. For example, the minimum period of time may be factory preset for the particular electronic device, may be selected by the controller, may be selected directly by the user, or may be indirectly selected by the user (e.g., via selection of various power management profiles).

If the total charge is sufficient, the secondary power supply is discharged in order to power the selected logical circuit for at least the predetermined minimum period of time, at block 606. If the total charge is not sufficient, the controller may determine, at block 608, if there is any other logical circuit on the list of logical circuits with a lower priority that can be powered by the total charge for at least the predetermined minimum period of time. If there are not any other logical circuits on the list that meet the criteria of block 608, the secondary power source continues to collect charges from the PETA layer (e.g., via the capacitor array layer). If there is another logical circuit that meets the criteria of block 608, the controller selects the logical circuit that meets the criteria, at block 612, and discharges the secondary power supply to power the selected logical circuit for at least the predetermined minimum period of time, at block 606.

Although not shown in FIG. 6, more than one logical circuit may be selected to be simultaneously powered by the discharge of the secondary power supply, presuming the total charge is sufficient to power more than one logical circuit simultaneously. Alternatively, the discharge of the secondary power supply may be used to serially power more than one logical circuit (e.g. power the highest priority logical circuit and then power the next highest logical circuit).

In some circumstances, the secondary power supply could directly collect the charges from the PETA layer by either omitting the capacitor array layer or bypassing the capacitor array layer. Likewise, the battery of the electronic device could directly collect the charges from the PETA layer by either omitting the capacitor array layer or bypassing the capacitor array layer. Similarly, any of the logical circuits could be directly powered by the PETA layer be either omitting the capacitor array layer or bypassing the capacitor array layer.

As can be readily seen by the foregoing description, numerous advantages may be obtained by utilizing the disclosed embodiments. For example, the battery of an electronic device with a power-generating touch screen will not need to be recharged as often since power can be generated through use of the touch screen. In some embodiments, the touch screen can also generate power when the electronic device is turned off or in a low-power mode (e.g., standby mode).

In one or more exemplary embodiments, the functions described may be implemented in hardware, software, firmware, or any combination thereof. If implemented in software, the functions may be stored as one or more instructions or code on a computer-readable medium. For example, computer code that may be used by the controller to determine the charge level of the capacitor array layer and to control discharge of the capacitor array layer may be stored on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the disclosed embodiments.

The methods disclosed herein comprise one or more steps or actions for achieving the described method. The method steps and/or actions may be interchanged with one another without departing from the scope of the claims. In other words, unless a specific order of steps or actions is required for proper operation of the method that is being described, the order and/or use of specific steps and/or actions may be modified without departing from the scope of the claims. Additionally, various steps may be omitted, substituted, or added to the particular methods described above without departing from the scope of the disclosed embodiments.

Clearly, other embodiments and modifications will occur readily to those of ordinary skill in the art in view of these teachings. The above description is illustrative and not restrictive. These embodiments are to be limited only by the following claims, which include all such embodiments and modifications when viewed in conjunction with the above specification and accompanying drawings. The scope of the embodiments should, therefore, be determined not with reference to the above description, but instead should be determined with reference to the appended claims along with their full scope of equivalents.

What is claimed is:

1. A power-generating touch screen comprising:
a piezoelectric transducer array (PETA) layer comprising a plurality of piezoelectric transducer (PET) elements; and
a capacitor array layer coupled to the PETA layer, the capacitor array layer comprising a plurality of capacitors, the PETA layer configured to provide a charge to the capacitors of the capacitor array layer when a force is applied to the PETA layer.

2. The power-generating touch screen of claim 1, further comprising:
a plurality of PETA layers, each of the plurality of PETA layers electrically coupled to the capacitor array layer.

3. The power-generating touch screen of claim 1, further comprising:
a touch sensor layer coupled to the PETA layer; and
a display layer coupled to the touch sensor layer.

4. An electronic device, comprising:
a controller; and
a power-generating touch screen coupled to the controller, the power-generating touch screen comprising:
a piezoelectric transducer array (PETA) layer comprising a plurality of piezoelectric transducer (PET) elements, and
a capacitor array layer coupled to the PETA layer, the capacitor array layer comprising a plurality of capacitors, the PETA layer configured to provide a charge to the capacitors of the capacitor array layer when a force is applied to the PETA layer.

5. The electronic device of claim 4, wherein the controller is configured to determine a charge level of the capacitor array layer and to control discharge of the capacitor array layer based on the determined charge level.

6. The electronic device of claim 5, further comprising:
a battery to power the electronic device; and
circuitry to discharge the capacitor array layer in order to charge the battery.

7. The electronic device of claim 5, further comprising:
circuitry to discharge the capacitor array layer in order to power a logical circuit associated with the electronic device.

8. The electronic device of claim 7, wherein the logical circuit comprises one of the following: a real-time clock, a liquid crystal display, and a backlighting device.

9. The electronic device of claim 5, further comprising:
a secondary power source coupled to the capacitor array layer; and
circuitry to discharge the capacitor array layer in order to charge the secondary power source.

10. The electronic device of claim 9, wherein the secondary power source comprises an electrochemical capacitor.

11. The electronic device of claim 9, further comprising:
a battery to power the electronic device; and
circuitry to discharge the secondary power source in order to charge the battery.

12. The electronic device of claim 9, further comprising:
circuitry to discharge the secondary power source in order to power a logical circuit associated with the electronic device.

13. A method comprising:
converting a force applied to a piezoelectric transducer array (PETA) layer of a touch screen into an electric charge; and
charging a capacitor array layer of the touch screen with the converted electric charge.

14. The method of claim 13, further comprising:
discharging the charged capacitor array layer to power a logical circuit of a device associated with the touch screen.

15. The method of claim 14, further comprising:
determining a charge level of the capacitor array layer; and
based on the determined charge level of the capacitor array layer, selecting one of a plurality of logical circuits to be powered by discharging the charged capacitor array layer.

16. The method of claim 15, wherein the selection of one of the plurality of logical circuits is also based on a priority level associated with the selected logical circuit.

17. The method of claim 16, wherein the selection of one of the plurality of logical circuits is also based on whether the determined charge level of the capacitor array layer is sufficient to power the selected logical circuit for at least a predetermined minimum period of time.

18. The method of claim 13, further comprising:
discharging the charged capacitor array layer to charge a battery of a device associated with the touch screen.

19. The method of claim 13, further comprising:
discharging the charged capacitor array layer to charge a secondary power source.

20. The method of claim 19, further comprising:
discharging the charged secondary power source to power a logical circuit of a device associated with the touch screen.

21. The method of claim 19, further comprising:
discharging the charged secondary power source to charge a battery of the device associated with the touch screen.
